(19) United States
(12) Patent Application Publication
(10) Pub. No.: US 2006/0230759 A1
(43) Pub. Date: Oct. 19, 2006

(54) Variable geometry turbocharger

(76) Inventor: H. Albert Semrau, Holland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/105,213

(22) Filed: Apr. 13, 2005

(51) Int. Cl. F02D 23/00

(52) U.S. Cl. 60/602

(57) ABSTRACT

A turbine comprising a housing, a turbine wheel and at least one movable member. The housing has an interior, an inlet for allowing fluid to enter the interior and an outlet for allowing the fluid to exit the housing. The turbine wheel has turbine blades located in the housing. The at least one movable member is located within the housing and is positioned in a fluid path between the inlet and the turbine blades for selectively controlling a flow of fluid to the turbine blades in the housing.

### FIELD OF THE INVENTION

The present invention relates to turbine engines and, more particularly, pertains to a variable geometry turbine.

### BACKGROUND OF THE INVENTION

A limiting factor in the performance of an internal combustion engine is the amount of combustion air that can be delivered to the intake manifold for combustion in the engine cylinders. Atmospheric pressure is often inadequate to supply the required amount of air for proper operation of an engine.

An internal combustion engine may include one or more turbochargers for compressing a fluid to be supplied to one or more combustion chambers within corresponding combustion cylinders. Each turbocharger typically includes a turbine driven by exhaust gases from the engine, and a compressor driven by the turbine. The compressor receives the fluid to be compressed and supplies the compressed fluid to the combustion chambers. The fluid compressed by the compressor may be in the form of combustion air only, or may be a mixture of fuel and combustion air. Through the use of a turbocharger, the power available from an engine of any given size can be increased significantly. Thus, a smaller, less expensive engine may be used for a given power requirement, and power loss due to, for example, changes in altitude, can be compensated for.

Sizing a turbocharger for proper performance under all engine operating conditions can be difficult. In an exhaust gas turbocharger, exhaust gas flow and turbine design determine turbine performance, and thereby compressor performance and turbocharger efficiency. Vanes in the inlet throat or outlet nozzle of the turbine can be used to influence flow characteristics through the turbine, and thereby the turbine power generated for a given exhaust gas flow. If the engine is to be operated at or near full load during most of its operating cycle, it is not difficult to design the turbocharger for efficient performance. However, if the engine is to be operated at significantly less than full load for extended periods of time, it becomes more difficult to design a turbocharger that will perform well throughout the operating range of the engine. Desirably, the turbocharger will provide the required level of pressure boost, respond quickly to load changes, and function efficiently under both high load and low load conditions.

For an engine having a wide range of operating load, it has been known to size the turbine for proper performance under full load conditions. A problem with this approach is that the turbocharger responds slowly at low speed, and the boost pressure available at low engine speeds is minimal. As an alternative, it has been known to provide a turbine design that exceeds the power requirements at full load, and to use a waste gate to bypass excess exhaust gas flow after the turbocharger has reached the desired boost level. An “oversized” turbine of this type will provide greater boost at lower load conditions, and will respond more quickly at lower speeds, but engine back pressure is increased and the energy in the bypassed exhaust flow is wasted.

It is known to control turbocharger performance by controlling exhaust gas flow through the turbine of the turbocharger. Controllable vanes in the turbine throat and/or nozzle exit have been used to control turbine efficiency, and thereby turbocharger performance. Pivotable vanes connected by linkage to a control ring have been used. Rotation of the ring changes the vane angle, and thereby the flow characteristics of the exhaust gas through the turbine. U.S. Pat. No. 4,490,622 discloses a turbocharger in which nozzle vanes are spaced circumferentially about the turbine rotor, and a control linkage controls the position of the nozzle vanes, to vary the flow of exhaust gases to the turbine.

Many of the known variable nozzle designs are complex, having numerous pivotal connections and complex linkages. Such complex designs may be prone to failure and wear.

Accordingly, an apparatus is desired having the aforementioned advantages and solving and/or making improvements on the aforementioned disadvantages.

### SUMMARY OF THE PRESENT INVENTION

An aspect of the present invention is to provide a turbine comprising a housing, a turbine wheel and at least one movable member. The housing has an interior, an inlet for allowing fluid to enter the interior and an outlet for allowing the fluid to exit the housing. The turbine wheel has turbine blades located in the housing. The at least one movable member is within the housing and is positioned in a fluid path between the inlet and the turbine blades for selectively controlling a flow of fluid to the turbine blades in the housing. The at least one movable member is configured to substantially stop the flow of fluid to the turbine blades.

Another aspect of the present invention is to provide a turbocharger subassembly comprising a housing, a blade wheel and a single rotating throttle plate. The housing has a substantially disc-shaped interior and an intake channel having an inlet and an exit leading into the interior, with the intake channel being adapted for accepting fluid therein and supplying the fluid to the interior. The housing further has an axial outlet for allowing the fluid to exit the housing. The blade wheel is in the housing. The single rotating throttle plate is within the housing and is positioned between the inlet of the intake channel and the blade wheel for selectively controlling a flow of fluid to the blade wheel in the housing and a tangential velocity of the fluid in the disc-shaped interior of the housing.

Yet another aspect of the present invention is to provide a turbocharger subassembly comprising a housing, a blade wheel and a single rotating member. The housing has an interior, an inlet for allowing fluid to enter the interior and an outlet for allowing the fluid to exit the housing. The blade wheel is in the housing. The single rotating member surrounds the blade wheel within the housing and is positioned between the inlet and the blade wheel for selectively controlling a flow of fluid to the blade wheel in the housing. The housing includes a stationary wall surrounding the blade wheel, with the stationary wall including at least one first opening. The single rotating member includes at least one second opening configured to be selectively aligned with the at least one first opening as the single rotating member is rotated to control an amount of the fluid reaching the blade wheel.

A further aspect of the present invention is to provide a turbocharger assembly comprising a turbine including a turbine housing having an inlet and outlet, with the turbine further including a turbine wheel having turbine blades. The turbocharger assembly further includes a compressor including a compressor housing having an inlet and an outlet, with the compressor further including a compressor wheel having compressor blades. The turbocharger assembly also includes a shaft extending between and into the turbine housing and the compressor housing, with the shaft having the turbine wheel connected thereto adjacent a first end of the shaft and the compressor wheel connected thereto adjacent a second end of the shaft. The turbine includes at least one movable member within the turbine housing and positioned between the inlet and the turbine wheel for selectively controlling a flow of fluid to the turbine wheel. The fluid flowing through the turbine rotates the turbine wheel and the shaft, thereby rotating the compressor wheel in the compressor to compress fluid flowing through the compressor. The at least one movable member is configured to substantially stop the flow of fluid to the turbine blades.

These and other aspects, objects, and features of the present invention will be understood and appreciated by those skilled in the art upon studying the following specification, claims, and appended drawings.

### BRIEF DESCRIPTION OF DRAWINGS

FIG. 1 is a cross-sectional view of a turbocharger assembly of the present invention.

FIG. 2 is an exploded perspective view of a radial turbine, a shaft and a shaft housing of the turbocharger assembly of the present invention.

FIG. 3 is a cross-sectional side view of a first embodiment of the radial turbine of the present invention having a movable member in a closed position.

FIG. 4 is a cross-sectional side view of the first embodiment of the radial turbine of the present invention having the movable member in a partially open position.

FIG. 5 is a cross-sectional side view of the first embodiment of the radial turbine of the present invention having the movable member in the fully open position.

FIG. 6 is a cross-sectional side view of a second embodiment of the radial turbine of the present invention having the movable member in a closed position and open positions in phantom.

FIG. 7 is a cross-sectional side view of a third embodiment of the radial turbine of the present invention having the movable member in a closed position.

FIG. 8 is a cross-sectional side view of the third embodiment of the radial turbine of the present invention having the movable member in a partially open position.

FIG. 9 is a cross-sectional side view of the third embodiment of the radial turbine of the present invention having the movable member in the fully open position.

FIG. 10 is an exploded perspective view of the third embodiment of the radial turbine of the present invention.

FIG. 10A is a perspective view of an actuating assembly and a single rotating member of the third embodiment of the radial turbine of the present invention.

FIG. 10B is a top view of an actuating assembly and a single rotating member of the present invention in a first rotated position.

FIG. 10C is a top view of an actuating assembly and a single rotating member of the present invention in a second rotated position.

FIG. 11 is a cross-sectional side view of a fourth embodiment of the radial turbine of the present invention having the movable member in a closed position.

FIG. 12 is a cross-sectional side view of the fourth embodiment of the radial turbine of the present invention having the movable member in a partially open position.

FIG. 13 is a cross-sectional side view of the fourth embodiment of the radial turbine of the present invention having the movable member in the fully open position.

### DETAILED DESCRIPTION OF PREFERRED EMBODIMENTS

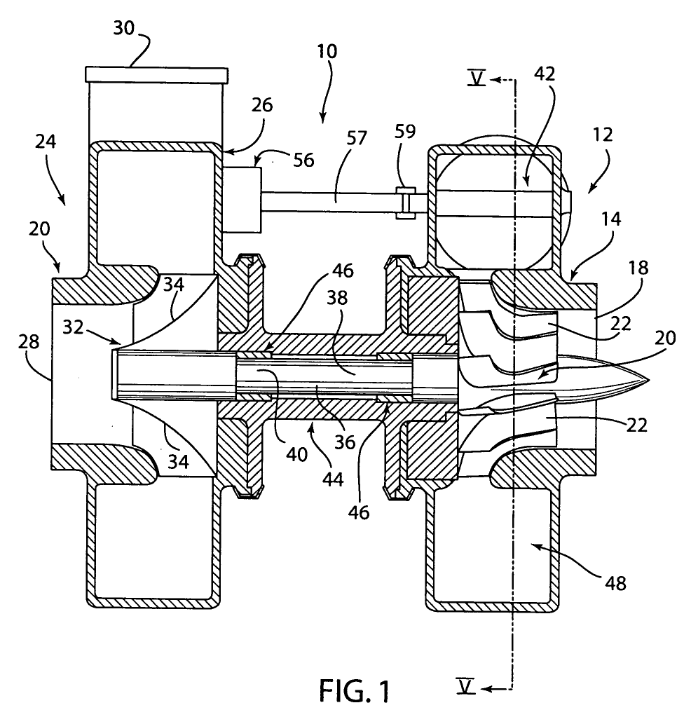

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

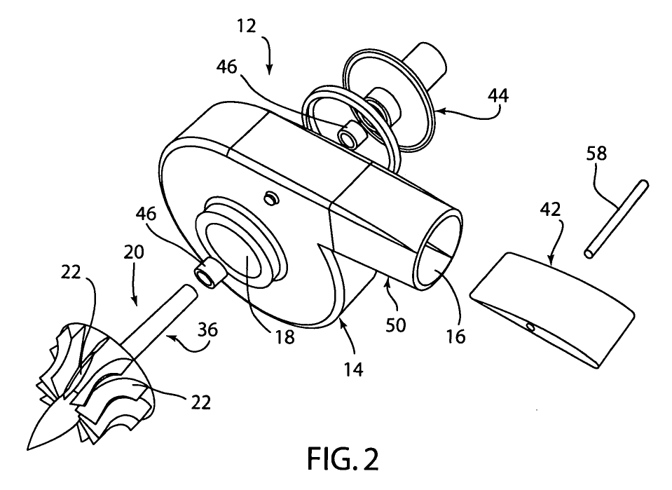

The reference number 10 (FIGS. 1-2) generally designates a turbocharger assembly embodying the present invention. In the illustrated example, the turbocharger assembly 10 comprises a turbine 12 including a turbine housing 14 having an inlet 16 and outlet 18, with the turbine 12 further including a turbine wheel 20 having turbine blades 22. The turbocharger assembly 10 further includes a compressor 24 including a compressor housing 26 having an inlet 28 and an outlet 30 (see FIG. 2), with the compressor 24 further including a compressor wheel 32 having compressor blades 34. The turbocharger assembly 10 also includes a shaft 36 extending between and into the turbine housing 14 and the compressor housing 26, with the shaft 36 having the turbine wheel 20 connected thereto adjacent a first end 38 of the shaft 36 and the compressor wheel 32 connected thereto adjacent a second end 40 of the shaft 36. The turbine 12 includes at least one movable member 42 within the turbine housing 14 and positioned between the inlet 16 and the turbine wheel 20 for selectively controlling a flow of fluid to the turbine wheel 20. The at least one movable member also controls tangential velocity of the fluid in the turbine housing 14. The fluid flowing through the turbine 12 rotates the turbine wheel 20 and the shaft 36, thereby rotating the compressor wheel 32 in the compressor 24 to compress fluid flowing through the compressor 24.

In the illustrated embodiment, the turbocharger assembly 10 is configured to be used in an exhaust turbocharger. In exhaust turbochargers, exhaust gas from an engine (e.g., in passenger vehicles, marine engines, diesel engines, marine and locomotion power plants, stationary power generators, etc.) is supplied to the inlet 16 of the turbine housing 14 of the turbine 12. As the exhaust gas flows through the turbine 12, the exhaust gas flows against the turbine blades 22, thereby rotating the turbine blades 22 and the turbine wheel 20. As the turbine wheel 20 rotates, the associated shaft 36 also rotates, thereby rotating the compressor wheel 32 and the compressor blades 34 in the compressor 24. The compressor 24 accepts atmospheric fresh air into the inlet 28 of the compressor housing 26, where the compressor blades 34 compress the air before the air is outputted out of the outlet 30 of the compressor housing 26. The air compressed in the compressor 24 is supplied to cylinders in the engine in compressed form, thereby improving the efficiency of the engine. Typically, the compressor housing 26 is made of cast aluminum. In the illustrated example, the shaft 36 is located in a shaft housing 44 located between the compressor housing 26 and the turbine housing 14. The shaft housing 44 includes a plurality of bearings 46 for allowing the shaft 36 and the compressor wheel 32 and turbine wheel 20 to easily rotate. Furthermore, the shaft housing 44 can be connected to a lube-oil circuit of the engine for lubrication and the shaft housing 44 can be cooled when (e.g., water-cooled), for example, the high temperature of the exhaust gas requires cooling. An exhaust turbocharger as described directly above is well known to those skilled in the art.

The illustrated turbine 12 (FIGS. 1-5) accepts exhaust gas (or any other fluid) therein to power the turbine wheel 20 and, therefore, the compressor wheel 32. The turbine 12 includes the turbine housing 14 having the inlet 16 and the outlet 18. In the illustrated embodiment, the turbine housing 14 is for a radial turbine. The turbine housing 14 includes a substantially disc-shaped interior 48 and an intake channel 50 having the inlet 16 and an exit 52 leading into the interior 48. The intake channel 50 is adapted for accepting the exhaust gas therein through the inlet 16 and supplying the exhaust gas to the interior 48 through the exit 52. The turbine wheel 20 and the turbine blades 22 are located in the turbine housing 14. In the illustrated example, the outlet 18 is an axial outlet (see FIGS. 1 and 2) for allowing the fluid to exit the turbine housing 14. In use, the exhaust gas flows into the intake channel 50 through the inlet 16 and then into the interior 48 through the exit 52 of the intake channel 50. The exhaust gas then flows in a circular pattern in the interior 48 and impels against the turbine blades 22 to turn the turbine wheel 20. The exhaust gas then exits the turbine housing 14 through the outlet 18. It is contemplated that the turbine housing 14 can be cast from GGG 40 or NiResist D5. In the illustrated embodiment, the intake channel 50 and the interior 48 of the turbine housing 14 are for a single intake turbine. However, it is contemplated that the intake channel 50 and the interior 48 could be used in a twin-flow turbine in which two streams of exhaust gas flow join just before reaching the turbine blades 22.

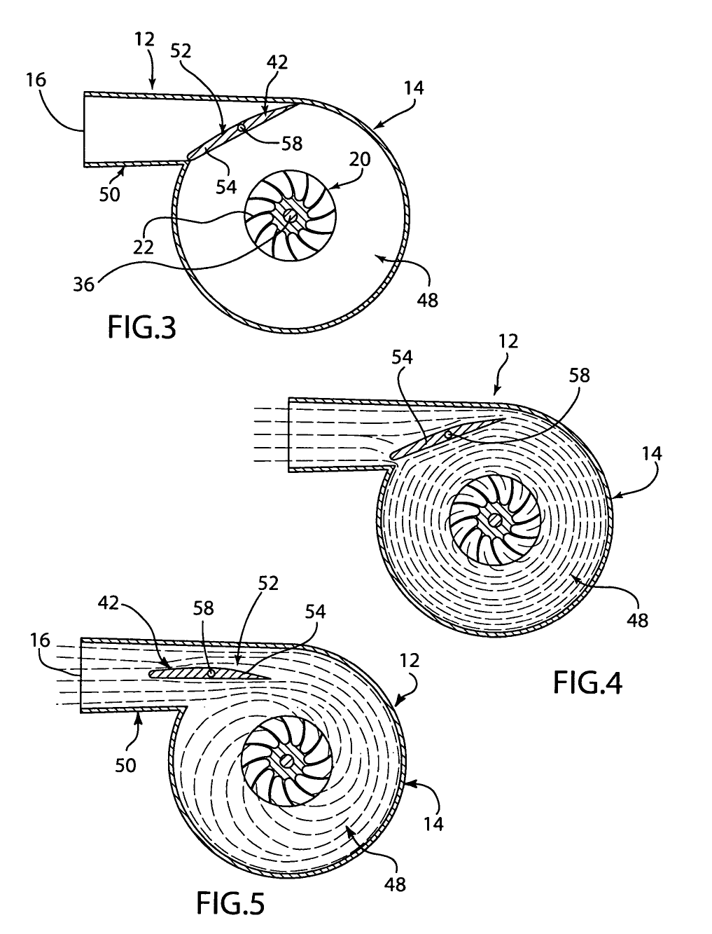

In a first embodiment of the illustrated invention, the at least one movable member 42 comprises a single throttle valve 54 (FIGS. 3-5) positioned within the turbine housing 14. In the illustrated embodiment, the single throttle valve 54 is located adjacent the exit 52 of the intake channel 50 to control the flow of fluid into the interior 48 and therefore to the turbine blades 22. However, it is contemplated that the single throttle valve 54 could be located anywhere in the turbine housing 14 between the inlet 16 to the turbine housing 14 and the turbine blades 22. For example, the single throttle valve 54 could be positioned anywhere in the intake channel 50. The illustrated throttle valve 54 can also control the tangential velocity of the fluid in the turbine housing 14 as discussed below. However, to control the tangential velocity, the throttle valve 54 is preferably located adjacent the exit 52 of the intake channel 50. In the illustrated example, the turbine 12 includes an actuator 56 (see FIG. 1) connected to the compressor housing 26, with the actuator 56 having a drive shaft 57 connected via a coupling 59 to a pivot pin 58 inserted into the turbine housing 14 and connected to the single throttle valve 54 for pivoting the single throttle valve 54. Preferably, the single throttle valve 54 is an airfoil. However, it is contemplated that the throttle valve 54 could be any member capable of stopping the flow to the turbine wheel 20.

The illustrated single throttle valve 54 selectively controls a flow of fluid to the turbine wheel 20 of the turbine 12. As illustrated in FIG. 3, the single airfoil 54 has a closed position that substantially stops the flow of fluid to the turbine blades 22. Stopping the flow of fluid to the turbine blades 22 allows the turbocharger assembly 10 to assist in achieving high engine braking power. The single throttle valve 54 also has an infinitely variable partially open position as illustrated in FIG. 4. When the throttle valve 54 is in the partially open position, the exhaust gas flows by the throttle valve 54 and into the interior 48 of the turbine housing 14. The throttle valve 54 can be controlled to maximize the tangential velocity of the fluid for a given throughput. FIG. 5 illustrates the throttle valve 54 in the fully open position which allows the exhaust gas to flow into the interior 48 at a faster rate than the partially open position. The actuator 56 can rotate the pivot pin 58 to thereby rotate the throttle valve 54 anywhere between the closed position and the fully open position. Preferably, the throttle valve 54 rotates about a central axis. The angular position of the throttle valve 54 can be controlled (e.g., electronically, pneumatically, hydraulically, etc.) by the actuator 56 in order to achieve a maximum tangential velocity at the desired throughput of the exhaust gas. The high tangential velocity results in a high torque and/or high rotational speed of the turbine wheel 20 to maximize the efficiency of the turbocharger assembly 10. Moreover, the throttle valve 54 can be used to stop the flow of fluid to the turbine wheel 20, thereby achieving a high back-pressure which enhances the engine's braking power. This braking power is particularly useful (although not limited to) Diesel engines. Furthermore, the throttle valve 54 directs the exhaust gas to move on a volute path towards the turbine blades 22. Although not shown, it is contemplated that the throttle valve 54 can work in combination with stationary flow directors to force the exhaust gas to move with the high tangential velocity on the volute path. Additionally, it is contemplated that two airfoils 54 could be used in a twin-flow turbine, with one throttle valve 54 in each flow path. Alternatively, one throttle valve 54 could be used to control the flow of both paths of the twin-flow turbine.

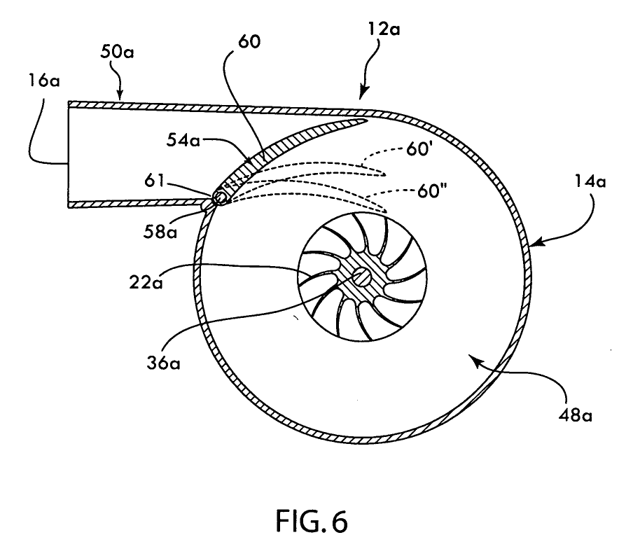

The reference numeral 12a (FIG. 6) generally designates another embodiment of the present invention, having a second embodiment for the turbine. Since turbine 12a is similar to the previously described turbine 12, similar parts appearing in FIGS. 1-5 and FIG. 6, respectively, are represented by the same, corresponding reference number, except for the suffix “a” in the numerals of the latter. The second embodiment of the turbine 12a includes a movable member 54a in the form of a rotatable vane 60 positioned at the exit 52 of the intake channel 50. The vane 60 is pivotable about a lower end 61 by the pivot pin 58a. The vane 60 includes a closed position as shown with solid lines in FIG. 6. The vane 60 also includes an infinitely variable partially open position as shown in phantom as the vane 60′ and a fully open position as shown in phantom as the vane 60″. Like the throttle valve 54 of the first embodiment of the turbine 12, the vane 60 in the closed position substantially stops the flow of fluid to the turbine blades 22a. Furthermore, when the vane 60′ is in the partially open position, the exhaust gas flows by the vane 60′ and into the interior 48a of the turbine housing 14a. Moreover, when the vane 60″ is in the fully open position, the exhaust gas flows into the interior 48s at a faster rate than the partially open position. The actuator 56a can rotate the vane 60 to thereby rotate the vane 60 anywhere between the closed position and the fully open position. The angular position of the vane 60 can be controlled (e.g., electronically, pneumatically, hydraulically, etc.) by the actuator 56a in order to achieve a maximum tangential velocity at the desired throughput of the exhaust gas. The high tangential velocity results in a high torque and/or high rotational speed of the turbine wheel 20a to maximize the efficiency of the turbocharger assembly 10a. Furthermore, the vane 60 directs the exhaust gas to move on a volute path towards the turbine blades 22a. Although not shown, it is contemplated that the vane 60 can work in combination with stationary flow directors to force the exhaust gas to move with the high tangential velocity on the volute path. Additionally, it is contemplated that two vanes 60 could be used in a twin-flow turbine, with one vane 60 in each flow path. Alternatively, one vane 60 could be used to control the flow of both paths of the twin-flow turbine.

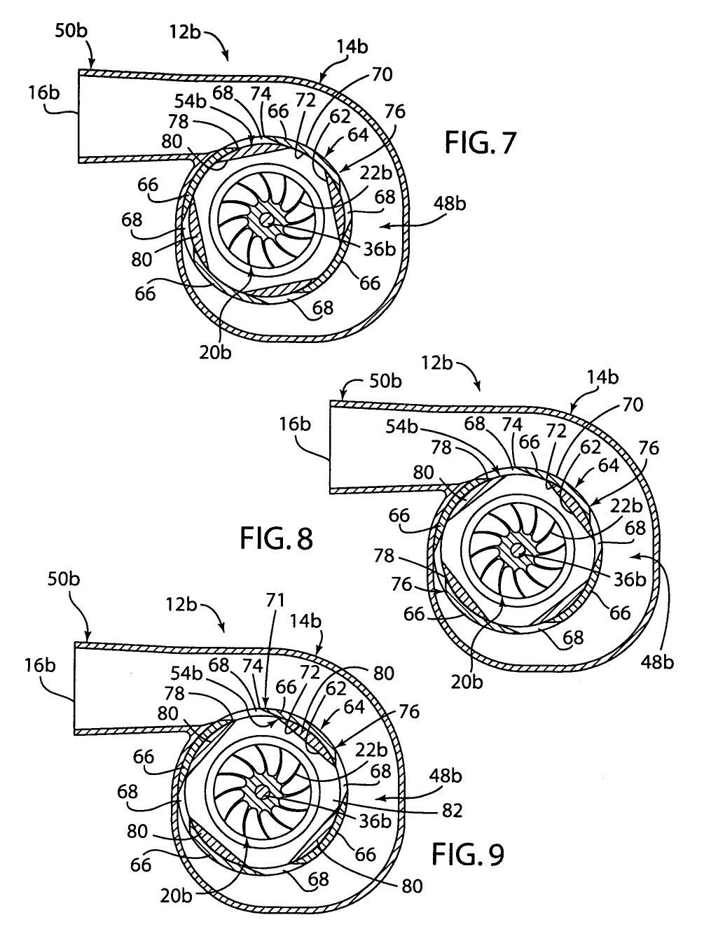

The reference numeral 12b (FIGS. 7-10) generally designates another embodiment of the present invention, having a third embodiment for the turbine. Since turbine 12b is similar to the previously described turbine 12, similar parts appearing in FIGS. 1-5 and FIGS. 7-10, respectively, are represented by the same, corresponding reference number, except for the suffix “b” in the numerals of the latter. The third embodiment of the turbine 12b includes a movable member 54b in the form of a single rotating member 62 surrounding the turbine wheel 20b that works in combination with a stationary wall 64 in the turbine housing 14b surrounding the turbine wheel 20b to control a flow of fluid to the turbine blades 22b.

The illustrated stationary wall 64 comprises at least one arcuate partition 66 surrounding the turbine blades 22b, with the arcuate partition 66 defining at least one first opening 68 allowing the exhaust gas to reach the turbine blades 22b through the at least one first opening 68. In the illustrated embodiment, the at least one arcuate partition 66 and the at least one first opening 68 includes four arcuate partitions 66 and four first openings 68. However, it is contemplated that any number of arcuate partitions 66 and first openings 68 can be employed. The arcuate partitions 66 each include an outside surface 70 and an inside surface 72. A first end 71 of each arcuate partition 66 tapers from the inside surface 72 to the outside surface 70 such that the arcuate partition 66 comes to a point 74 at the first end 71. The first end 71 helps to direct the exhaust gas towards the turbine blades 22b. A second end 76 of each arcuate partition 66 tapers from the outside surface 70 to the inside surface 72 such that the arcuate partition 66 comes to a point 78 at the second end 76. The second end 76 helps to direct the exhaust gas into the first openings 68.

In the illustrated example, the arcuate partitions 66 of the stationary wall 64 surrounds the single rotating member 62, which is configured to rotate within the stationary wall 64 to control a flow of exhaust gas through the at least one first opening 68 and to the turbine blades 22b. The single rotating member 62 includes at least one panel 80 defining at least one second opening 82. In the illustrated embodiment, the single rotating member 62 includes four panels 80 and four openings 82. However, it is contemplated that the single rotating member 62 could include any number of panels 80 and openings 82. Preferably, the single rotating member 62 includes a number of panels 80 and openings 82 corresponding to the number of partitions 66 and openings 68, respectively, in the stationary wall 64. The single rotating member 62 is configured to rotate to position the panels 80 behind the openings 68 in the stationary wall 64 to at least partially block the openings 68. The single rotating member 62 has a closed position as shown in FIG. 7, wherein the panels 80 fully block the openings 68 in the stationary member 64, thereby substantially stopping the flow of fluid to the turbine blades 22b. The single rotating member 62 also has a partially open position as illustrated in FIG. 8, wherein the second openings 82 are partially aligned with the first openings 68. When the single rotating member 62 is in the partially open position, the exhaust gas flows through the openings 68 in the stationary wall 64 and into the interior 48b of the turbine housing 14b. FIG. 9 illustrates the rotating member 62 in the fully open position wherein the second openings 82 are aligned with the first openings 68, which allows the exhaust gas to flow through the first openings 68 and into the interior 48 at a faster rate than the partially open position.

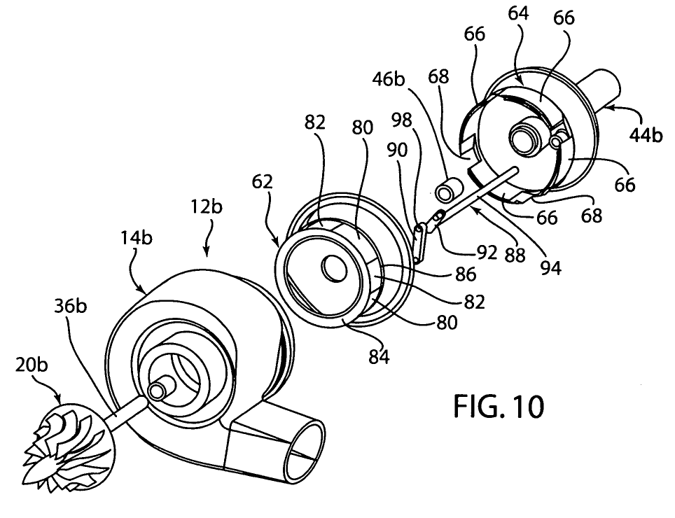

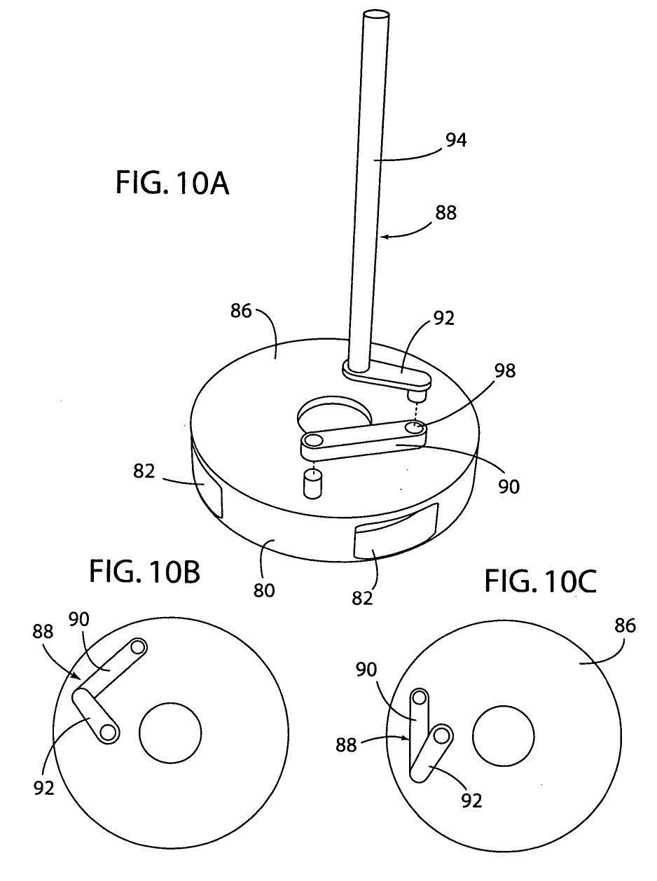

The illustrated rotating member 62 includes a first circular connection 84 and a second circular connection 86 connecting the panels 80. The rotating member 62 is rotated using an actuating assembly 88 (see FIGS. 10-10C). The actuating assembly 88 includes a first lever 90 connected to the second circular connection 86 and a second lever 92 connected to the first lever 90 and an actuating rod 94. The actuating rod 94 extends through the housing 14b and is connected to the actuator. The actuator rotates the actuating rod 94, which is rigidly connected to the second lever 92. As the second lever 92 rotates about the rotating rod 94, the second lever 92 will pivot in a first hole 98 of the first lever 90, thereby driving the first lever 90 and the second circular connection 86. When the first lever 90 and the second circular connection 86 are driven by the second lever 92, the rotating member 62 pivots. Accordingly, the actuator controls the rotation of the rotating member 62 to move the rotating member 62 between the closed position and the fully open position as described above. FIG. 10B illustrates the actuating assembly 88 and the single rotating member 62 in a first position. FIG. 10C illustrates the actuating assembly 88 and the single rotating member 62 in a second position. It is contemplated that other means to rotate the rotating member 62 could be employed.

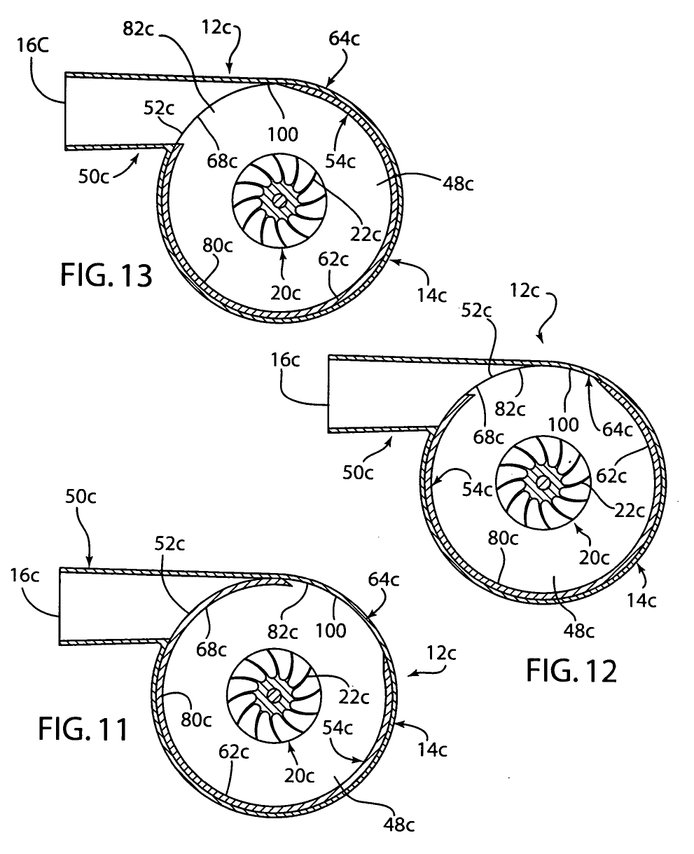

The reference numeral 12c (FIGS. 11-13) generally designates another embodiment of the present invention, having a fourth embodiment for the turbine. Since turbine 12c is similar to the previously described turbine 12b, similar parts appearing in FIGS. 7-10 and FIGS. 11-13, respectively, are represented by the same, corresponding reference number, except for the suffix “c” in the numerals of the latter. The fourth embodiment of the turbine 12c includes a movable member 54c in the form of a single rotating member 62c surrounding the turbine wheel 20c that works in combination with a stationary wall 64c of the turbine housing 14c surrounding the turbine wheel 20c to control a flow of fluid to the turbine blades 22c.

The illustrated stationary wall 64c is a circular perimeter inner wall 100 of the interior 48c of the turbine housing 14c. The circular perimeter inner wall 100 intersects the intake channel 50c at the exit 52c, thereby defining a first opening 68c co-extensive with the exit 52c of the intake channel 50c. In the illustrated example, the single rotating member 62c is configured to rotate within the stationary wall 64c to control a flow of exhaust gas through the first opening 68c and to the turbine blades 22c. The single rotating member 62c includes a circular panel 80c defining a second opening 82c. The single rotating member 62c is configured to rotate to position the single rotating member 62c behind the opening 68c in the circular perimeter inner wall 100 to at least partially block the opening 68c. The single rotating member 62c has a closed position as shown in FIG. 11, wherein the single rotating member 62c fully blocks the opening 68c in the circular perimeter inner wall 100, thereby substantially stopping the flow of fluid to the turbine blades 22c. The single rotating member 62c also has a partially open position as illustrated in FIG. 12, wherein the second opening 82c is partially aligned with the first opening 68c. When the single rotating member 62c is in the partially open position, the exhaust gas flows through the opening 68c in the circular perimeter inner wall 100 and into the interior 48c of the turbine housing 14c. FIG. 13 illustrates the rotating member 62c in the fully open position wherein the second opening 82c is aligned with the first opening 68c, which allows the exhaust gas to flow through the first opening 68c and into the interior 48c at a faster rate than the partially open position. It is contemplated that the rotating member 62c can be rotated by any means. For example, the rotating member 62c of the fourth embodiment of the turbine 12c can be rotated using a system similar to the actuating assembly 88 of the third embodiment of the turbine 12b.

It is to be understood that variations and modifications can be made on the aforementioned structure without departing from the concepts of the present invention. For example, the shaft 36 can be used to drive any accessory, like a generator, instead of or in addition to the compressor wheel 32. Moreover, it is contemplated that the single rotating member 62 could be located between the stationary wall 64 and the circular perimeter inner wall 100 of the turbine housing 14. Furthermore, it is to be understood that such concepts are intended to be covered by the following claims unless these claims by their language expressly state otherwise.

We claim:

1. A turbine comprising:
a housing having an interior, an inlet for allowing fluid to enter the interior and an outlet for allowing the fluid to exit the housing;
a turbine wheel having turbine blades located in the housing; and
at least one movable member within the housing and positioned in a fluid path between the inlet and the turbine blades for selectively controlling a flow of fluid to the turbine blades in the housing;
the at least one movable member being configured to substantially stop the flow of fluid to the turbine blades.

2. The turbine of claim 1, wherein:
the interior is substantially cylindrical.

3. The turbine of claim 1, wherein:
the at least one movable member is a single rotating throttle plate.

4. The turbine of claim 3, wherein:
the throttle plate is an airfoil.

5. The turbine of claim 3, wherein:
the housing comprises an intake channel, the intake channel having the inlet and an exit leading into the interior; and
the single rotating throttle plate is located adjacent the exit of the intake channel.

6. The turbine of claim 5, further including:
an actuator for rotating the single rotating throttle plate.

7. The turbine of claim 1, wherein:
the at least one movable member is a pivoting vane.

8. The turbine of claim 7, wherein:
the housing comprises an intake channel, the intake channel having the inlet and an exit leading into the interior; and
the pivoting vane is located adjacent the exit of the intake channel.

9. The turbine of claim 1, wherein:
the at least one movable member comprises a single rotating member surrounding the turbine wheel within the housing;
the housing includes a stationary wall surrounding the turbine wheel, the stationary wall including at least one first opening; and
the single rotating member includes at least one second opening configured to be selectively aligned with the at least one first opening as the single rotating member is rotated to control an amount of the fluid reaching the turbine wheel.

10. The turbine of claim 9, wherein:
the interior of the housing includes a perimeter inner wall; and
the stationary housing is spaced from the perimeter inner wall.

11. The turbine of claim 10, wherein:
the at least one first opening comprises at least four first openings; and
the at least one second opening comprises at least four second openings.

12. The turbine of claim 9, wherein:
the single rotating member is positioned between the stationary wall and the turbine wheel.

13. The turbine of claim 9, wherein:
the stationary wall is an inner perimeter wall of the interior of the housing;
the housing comprises an intake channel, the intake channel having the inlet and an exit leading into the interior, the exit defining the at least one first opening; and
the rotating member is located adjacent the inner perimeter wall of the interior of the housing and is configured to rotate to stop fluid flow through the exit of the intake channel.

14. The turbine of claim 1, wherein:
the housing is a single flow housing.

15. A turbocharger subassembly comprising:
a housing having a substantially disc-shaped interior, an intake channel having an inlet and an exit leading into the interior, the intake channel being adapted for accepting fluid therein and supplying the fluid to the interior, the housing further having an axial outlet for allowing the fluid to exit the housing;
a blade wheel in the housing; and
a single rotating throttle plate within the housing and positioned between the inlet of the intake channel and the blade wheel for selectively controlling a flow of fluid to the blade wheel in the housing and a tangential velocity of the fluid in the disc-shaped interior of the housing.

16. The turbocharger subassembly of claim 15, wherein:
the single rotating throttle plate is located adjacent the exit of the intake channel.

17. The turbocharger subassembly of claim 16, further including:
an actuator for rotating the single rotating throttle plate.

18. The turbocharger subassembly of claim 15, wherein:
the housing is a single flow housing.

19. The turbocharger subassembly of claim 15, wherein:
the throttle plate is configured to substantially stop the flow of fluid to the blade wheel.

20. The turbocharger subassembly of claim 15, wherein:
the single rotating throttle plate is an airfoil.

21. A turbocharger subassembly comprising:
a housing having an interior, an inlet for allowing fluid to enter the interior and an outlet for allowing the fluid to exit the housing;
a blade wheel in the housing; and
a single rotating member surrounding the blade wheel within the housing and positioned between the inlet and the blade wheel for selectively controlling a flow of fluid to the blade wheel in the housing;
the housing including a stationary wall surrounding the blade wheel, the stationary wall including at least one first opening; and
the single rotating member including at least one second opening configured to be selectively aligned with the at least one first opening as the single rotating member is rotated to control an amount of the fluid reaching the blade wheel.

22. The turbocharger subassembly of claim 21, wherein:
the interior of the housing includes a perimeter inner wall; and
the stationary housing is spaced from the perimeter inner wall.

23. The turbocharger subassembly of claim 22, wherein:
the at least one first opening comprises at least four first openings; and
the at least one second opening comprises at least four second openings.

24. The turbocharger subassembly of claim 21, wherein:
the single rotating member is positioned between the stationary wall and the turbine wheel.

25. The turbocharger subassembly of claim 21, wherein:
the stationary wall is an inner perimeter wall of the interior of the housing;
the housing comprises an intake channel, the intake channel having the inlet and an exit leading into the interior, the exit defining the at least one first opening; and
the rotating member is located adjacent the inner perimeter wall of the interior of the housing and is configured to rotate to stop fluid flow through the exit of the intake channel.

26. The turbocharger subassembly of claim 21, wherein:
the housing is a single flow housing.

27. The turbocharger subassembly of claim 21, wherein:
the single rotating member is configured to substantially stop the flow of fluid to the blade wheel.

28. A turbocharger assembly comprising:
a turbine including a turbine housing having an inlet and outlet, the turbine further including a turbine wheel having turbine blades;
a compressor including a compressor housing having an inlet and an outlet, the compressor further including a compressor wheel having compressor blades; and
a shaft extending between and into the turbine housing and the compressor housing, the shaft having the turbine wheel connected thereto adjacent a first end of the shaft and the compressor wheel connected thereto adjacent a second end of the shaft;
wherein the turbine includes at least one movable member within the turbine housing and positioned between the inlet and the turbine wheel for selectively controlling a flow of fluid to the turbine wheel;
wherein the fluid flowing through the turbine rotates the turbine wheel and the shaft, thereby rotating the compressor wheel in the compressor to compress fluid flowing through the compressor; and
wherein the at least one movable member is configured to substantially stop the flow of fluid to the turbine blades.

29. The turbocharger assembly of claim 28, wherein:
the turbine includes a substantially cylindrical interior.

30. The turbocharger assembly of claim 28, wherein:
the at least one movable member is a single rotating throttle plate.

31. The turbocharger assembly of claim 30, wherein:
the housing comprises an intake channel, the intake channel having the inlet and an exit leading into an interior of the housing; and
the single rotating throttle plate is located adjacent the exit of the intake channel.

32. The turbocharger assembly of claim 31, further including:
an actuator for rotating the single rotating throttle plate.

33. The turbocharger assembly of claim 30, wherein:
the single rotating throttle plate is an airfoil.

34. The turbocharger assembly of claim 28, wherein:
the at least one movable member is a pivoting vane.

35. The turbocharger assembly of claim 34, wherein:
the housing comprises an intake channel, the intake channel having the inlet and an exit leading into an interior of the housing interior; and
the pivoting vane is located adjacent the exit of the intake channel.

36. The turbocharger assembly of claim 28, wherein:
the at least one movable member comprises a single rotating member surrounding the turbine wheel within the housing;
the housing includes a stationary wall surrounding the turbine wheel, the stationary wall including at least one first opening; and
the single rotating member includes at least one second opening configured to be selectively aligned with the at least one first opening as the single rotating member is rotated to control an amount of the fluid reaching the turbine wheel.

37. The turbocharger assembly of claim 36, wherein:
an interior of the housing includes a perimeter inner wall; and
the stationary housing is spaced from the perimeter inner wall.

38. The turbocharger assembly of claim 37, wherein:
the at least one first opening comprises at least four first openings; and
the at least one second opening comprises at least four second openings.

39. The turbocharger assembly of claim 36, wherein:
the single rotating member is positioned between the stationary wall and the turbine wheel.

40. The turbocharger assembly of claim 36, wherein:
the stationary wall is an inner perimeter wall of an interior of the housing;
the housing comprises an intake channel, the intake channel having the inlet and an exit leading into the interior, the exit defining the at least one first opening; and
the rotating member is located adjacent the inner perimeter wall of the interior of the housing and is configured to rotate to stop fluid flow through the exit of the intake channel.

41. The turbocharger assembly of claim 28, wherein:
the housing is a single flow housing.
